(19) United States
(12) Patent Application Publication
(10) Pub. No.: US 2025/0281910 A1
(43) Pub. Date: Sep. 11, 2025

(54) FIBROUS SILICA LANTHANUM OXIDE-BASED CATALYST FOR DRY REFORMING OF METHANE AND METHODS OF PREPARATION THEREOF

(71) Applicant: KING FAHD UNIVERSITY OF PETROLEUM AND MINERALS, Dhahran (SA)

(72) Inventors: Khalid ALHOOSHANI, Dhahran (SA); Mohammed Mosaad AWAD, Dhahran (SA); Ijaz HUSSAIN, Dhahran (SA)

(73) Assignee: KING FAHD UNIVERSITY OF PETROLEUM AND MINERALS, Dhahran (SA)

(21) Appl. No.: 18/600,049

(22) Filed: Mar. 8, 2024

(51) Int. Cl. B01J 23/10; B01J 8/18; B01J 23/83; B01J 23/92; B01J 23/94; B01J 35/40; B01J 35/51; B01J 35/58; B01J 37/00; B01J 37/02; B01J 37/04; B01J 37/10; B01J 37/18; C01B 3/40; C01B 3/44

(52) U.S. Cl. CPC B01J 23/10; B01J 8/1827; B01J 23/83; B01J 23/92; B01J 23/94; B01J 35/40; B01J 35/51; B01J 35/58; B01J 37/0018; B01J 37/0201; B01J 37/04; B01J 37/10; B01J 37/18; C01B 3/40; C01B 3/44; C01B 2203/0238; C01B 2203/1005; C01B 2203/1058; C01B 2203/1082; C01B 2203/1241

(57) ABSTRACT

A method for dry reforming of methane (DRM) includes introducing and passing a hydrogen (H₂)-containing feed gas stream through a reactor to contact the H₂-containing feed gas stream with particles of a catalyst at a temperature of from 500° C. to 900° C. to form a reduced catalyst; introducing and passing a mixed feed gas stream comprising methane (CH₄) and carbon dioxide (CO₂) through the reactor to contact the mixed feed gas stream with the reduced catalyst at a temperature of from 500° C. to 1000° C. thereby converting at least a portion of the CH₄ and CO₂ to H₂/CO and regenerating the catalyst particles to form a regenerated catalyst and producing a residue gas stream leaving the reactor. The catalyst may be a fibrous silica lanthanum oxide (FSL) catalyst, and/or a nickel-containing FSL (Ni/FSL) catalyst.

### STATEMENT OF ACKNOWLEDGEMENT

Support provided by the Interdisciplinary Research Center for Refining & Advanced Chemicals, King Fahd University of Petroleum & Minerals, Dhahran 31261, Saudi Arabia, and the Department of Chemistry at King Fahd University of Petroleum and Minerals (KFUPM) for funding this work is gratefully acknowledged.

### BACKGROUND

### Technical Field

The present disclosure is directed towards catalysts for dry reforming of methane (DRM), particularly to a fibrous silica lanthanum oxide-based catalyst, and to a method for DRM using the fibrous silica lanthanum oxide-based catalyst.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Greenhouse gases (GHGs) may absorb and emit infrared light, a type of radiation emitted by the Earth. With the increasing demand for energy, there has been a growing reliance on fossil fuels, leading to the depletion of non-renewable resources and environmental challenges.

Additionally, methane and carbon dioxide (CO₂), as primary GHGs, contribute to the intensification of global warming. As a result, it is critical to make efforts to reduce CO₂ emissions, particularly in manufacturing sectors like the steel industry, known for emitting toxic gases. The steel industry faces the challenge of reducing CO₂ output and transitioning to cleaner fuel sources.

The production of hydrogen metallurgy may be accomplished by replacing hydrogen with carbon as the reducing agent. Hydrogen, with its abundant resources, high reaction rate, large calorific quality, and high thermal conductivity, could serve as a clean fuel. With this, CO₂ emissions may be reduced, and the dependence of the steel sector on fossil fuels might be decreased (See: W. Liu, H. Zuo, J. Wang, Q. Xue, B. Ren, and F. Yang, “The production and application of hydrogen in the steel industry,” Int J Hydrogen Energy, vol. 46, no. 17, pp).

One effective approach to utilizing GHGs, such as CO₂ and methane (CH₄), involves dry reforming of methane (DRM), leading to the production of syngas (H₂/CO) and other valuable products (See: A. H. K. Owgi and researchers., “Catalytic systems for enhanced carbon dioxide reforming of methane: a review,” Environ Chem Lett, vol. 19, no. 3). To improve DRM yield on an industrial scale, three key challenges need to be addressed: (i) improved activation of CO₂ and CH₄, (ii) understanding of the mechanisms and reaction routes leading to the fabrication of H₂ and carbon monoxide (CO), and (iii) methods that prevent the deactivation of catalyst processes. DRM reduces and consumes two GHGs whiling generating syngas at a molar ratio of about 1. By employing the Oxo- and Fischer-Tropsch synthesis procedures, this approach encourages the formation of crucial chemically produced hydrocarbons and compounds with high oxygen content. However, under alternate operating conditions that were not limited to the use of DRM, coke formation and associated side effects may occur.

The stability and rate of coke deposition on the catalytic surface play crucial roles in determining the effectiveness of the feature and support species employed in the DRM. As a result, the DRM process requires a catalyst with stability, prevent coke formation, and the ability to inhibit sintering. Over the years, many catalytic supports, which may be classified as mesoporous, have been utilized in DRM reactions, such as, but are not limited to, ZSM-5, SBA-15, MCM-41. Further, metal-oxides such as, but not limited to, Al₂O₃, ZrO₂, CeO₂, CaO, MgO, and SiO₂ groups have also been utilized as catalytic support for DRM reaction.

Mesoporous silica, known for its surface area, pore volume, and flexible pore diameter, stands out as a suitable support for DRM. These features resulted from the material's ability to provide many chemically reactive active spots (See: S. N. Bukhari, A. H. K. Owgi, N. Ainirazali, D.-V. N. Vo, and H. D. Setiabudi, “Enhanced catalytic performance of Ni SBA-15 towards CO₂ methanation via P123-assisted method,” Mater Today Proc, vol. 5, no. 10). In contrast, metal oxides are commonly chosen for their redox properties and strong oxygen mobility. Due to its high capacity to break the C—H and C—C bonds in CH₄ and CO₂ to fabricate syngas, nickel (Ni) is used as a non-precious transition metal for reforming operations. Ni-based catalysts are also cost-effective and efficient in the activity of catalyzing the DRM.

Despite the advantages of these catalysts, many are susceptible to inevitable catalytic degradation that results in the formation of carbon compounds. This degradation may lead to the collapse or obstruction of catalytic active spots, compromising catalytic stability, for example, mesoporous hexagonal molecular sieves prepared from SiO₂, such as MCM-41 and SBA-15 (See: C. T. Kresge, M. E. Leonowicz, W. J. Roth, J. C. Vartuli, and J. S. Beck, “Ordered mesoporous molecular sieves synthesized by a liquid-crystal template mechanism,” Nature, vol. 359, no. 6397). The aforementioned mesoporous silica exhibits characteristics that make it suitable for support applications, including well-ordered pores, high porosity, and pore diameters. Although internal surfaces of MCM-41 and SBA-15 may provide a large number of sites for active metal adhesion, access to reactants was constrained by the front-rear apertures of pore channels (See: L. P. Teh, S. Triwahyono, A. A. Jalil, M. L. Firmansyah, C. R. Mamat, and Z. A. Majid, “Fibrous silica mesoporous ZSM-5 for carbon monoxide methanation,” Appl Catal A Gen, vol. 523).

In this respect, there is a demand for DRM catalysts that are effective, active, and thermally stable. High surface area materials may be applied in the filed of DRM, as it exhibits an influence on the current condition of the active metal (dispersion and morphology). Although DRM have been done using metal-based catalysts, there has been an absence of DRM and its process using a catalyst-free of metal, preferably catalysts with suitable morphological features using various methods. Fibrous silica nanostructures were developed in 2010 at KAUST catalysis center (KCC-1) using a microemulsion approach followed by a microwave-assisted technique, resulting in silica fibers with improved surface areas and porosity (See: V. Polshettiwar, D. Cha, X. Zhang, and J. M. Basset, “High-Surface-Area Silica Nanospheres (KCC-1) with a Fibrous Morphology,” Angewandte Chemie International Edition, vol. 49, no. 50). Since its discovery, KCC-1 also finds applications as a support material in numerous catalytic processes, including drug delivery, hydro-isomerization of alkanes, and CO₂ capture (See: D.-S. Moon and J.-K. Lee, “Tunable Synthesis of Hierarchical Mesoporous Silica Nanoparticles with Radial Wrinkle Structure,” Langmuir, vol. 28, no. 33). The microemulsion method may also change the morphology of the silicate-1 zeolite from a coffin-shaped to an irregular new rod shape. On the other hand, a non-ionic microemulsion approach has been reported to generate platelet-shaped and sphere-shaped silicate-1 zeolite (See: S. Lee and D. F. Shantz, “Zeolite Growth in Nonionic Microemulsions: Synthesis of Hierarchically Structured Zeolite Particles,” Chemistry of Materials, vol. 17, no. 2).

Although several catalysts have been used in the past for DRM reactions, each of them suffers from one or more drawbacks that hinders their adoption. Hence, there is a need to develop more efficient DRM catalysts with enhanced effectiveness and to provide methods for incorporating these developed catalysts on an industrial scale for DRM.

In view of the foregoing, it is one objective of the present disclosure to provide a method for dry reforming of methane (DRM) in the presence of a catalyst. A second objective of the present disclosure is to provide a method of making the catalyst.

### SUMMARY

In an exemplary embodiment, a method for dry reforming of methane (DRM) is disclosed. The method includes introducing hydrogen (H₂)-containing feed gas stream into a reactor containing a catalyst. In some embodiments, the catalyst is at least one selected from the group consisting of a fibrous silica lanthanum oxide (FSL) catalyst, and a nickel-containing FSL (Ni/FSL) catalyst. The method further includes passing the H₂-containing feed gas stream through the reactor to contact the H₂-containing feed gas stream with particles of the catalyst at a temperature of from 500° C. to 900° C. to form a reduced catalyst. Furthermore, the method includes terminating the H₂-containing feed gas stream and introducing and passing a mixed feed gas stream including methane (CH₄) and carbon dioxide (CO₂) through the reactor. The method further includes contacting the mixed feed gas stream with the reduced catalyst at a temperature of from 500° C. to 1000° C. thereby converting at least a portion of the CH₄ and CO₂ to H₂ and CO. In addition, the method includes regenerating the catalyst particles to form a regenerated catalyst, and producing a residue gas stream leaving the reactor.

In some embodiments, H₂ is present in the H₂-containing feed gas stream at a concentration of 1 volume percentage (vol. %) to 20 vol. % based on a total volume of the H₂-containing feed gas stream.

In some embodiments, the H₂-containing feed gas stream further includes an inert gas selected from the group consisting of nitrogen, argon, and helium.

In some embodiments, the mixed feed gas stream further includes an inert gas selected from the group consisting of nitrogen (N₂), argon (Ar), and helium (He).

In some embodiments, the reactor is at least one selected from the group consisting of a fixed-bed reactor, a trickle-bed reactor, a moving bed reactor, a rotating bed reactor, a fluidized-bed reactor, and a slurry reactor.

In another exemplary embodiment, the reactor is disclosed. The reactor is a fluidized-bed reactor in the form of a cylindrical reactor including a top portion, a cylindrical body portion, a bottom portion, and a housing having an open top and open bottom supportably maintained with the cylindrical body portion. In some embodiments, the catalyst is supportably retained within the housing permitting fluid flow therethrough and at least one propeller agitator disposed in the bottom portion of the reactor. In some embodiments, the bottom portion is cone-shaped or pyramidal and a plurality of recirculation tubes fluidly connects the bottom portion of the cylindrical reactor with the cylindrical body portion of the cylindrical reactor.

In some embodiments, the passing of the H₂-containing feed gas stream through the reactor is carried out at a flow rate of about 10 milliliters per minute (ml/min) to 30 mL/min at a temperature of about 700° C.

In some embodiments, the passing of the mixed feed gas stream through the reactor is carried out at a flow rate of about 10 mL/min to 30 mL/min.

In some embodiments, a weight ratio of H₂ to CO present in the residue gas stream is in a range of 0.3 to 2.0.

In some embodiments, the method has an H₂ yield of 30% to 90% based on CH₄ conversion at a temperature of from 700° C. to 1000° C. In some embodiments, the CH₄ conversion is based on an initial concentration of the CH₄ in the mixed feed gas stream.

In some embodiments, the method has a CO yield of 25% to 48% based on a conversion of CH₄ and CO₂ at a temperature of from 700° C. to 1000° C. In some embodiments, the conversion of CH₄ and CO₂ is based on an initially combined concentration of the CH₄, and CO₂ present in the mixed feed gas stream.

In yet another exemplary embodiment, a method of preparation of the catalyst is disclosed. In some embodiments, the catalyst is the FSL catalyst, and the method further includes preparing the FSL catalyst by mixing urea, a quaternary ammonium surfactant, toluene, an alcohol solvent, and water to form a first mixture. The method further includes mixing lanthanum oxide (La₂O₃), a tetra alkyl orthosilicate, and the first mixture at a temperature of from 100° C. to 150° C. to form a second mixture, and calcining the second mixture at a temperature of about 500° C. to 600° C.

In some embodiments, the quaternary ammonium surfactant is at least one selected from the group consisting of cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyldimethylammonium bromide (DEDTAB), decyltrimethylammonium bromide (D10TAB), and dodecyltriphenylphosphonium bromide (DTPB).

In some embodiments, the tetra alkyl orthosilicate is at least one selected from the group consisting of tetraethyl orthosilicate (TEOS), tetramethyl orthosilicate, tetrapropyl orthosilicate, and tetrabutyl orthosilicate.

In some embodiments, the FSL catalyst includes about 10 weight percentage (wt. %) to 40 wt. % of lanthanum (La) as determined by energy-dispersive X-ray spectroscopy (EDS), and each wt. % based on the total weight of the FSL catalyst.

In some embodiments, the FSL catalyst has a porous structure including a plurality of spherical particles having an average particle size of 100 nanometers (nm) to 0.5 micrometer (μm).

In some embodiments, each of the plurality of spherical particles includes a fibrous network of interconnected nanoscale fibers having an average diameter of 0.5 nanometers (nm) to 25 nm.

In yet another exemplary embodiment, a method of preparing another catalyst is disclosed. In some embodiments, the catalyst is the Ni/FSL catalyst, and the method includes preparing the Ni/FSL catalyst by mixing a nickel (Ni) salt, the FSL catalyst, and water to form a third mixture, and further calcining the third mixture at a temperature of about 600° C. to 800° C.

In some embodiments, the Ni salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

In some embodiments, the Ni/FSL catalyst includes about 15 wt. % to 35 wt. % of La, 5 wt. % to 20 wt. % of Ni, 25 wt. % to 50 wt. % of oxygen (O), and 25 wt. % to 35 wt. % of silica (Si) as determined by EDS, and each wt. % based on a total weight of the Ni/FSL catalyst.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart depicting a method for the dry reforming of methane (DRM), according to certain embodiments;

FIG. 1B is a flowchart depicting a method for preparing the fibrous silica lanthanum oxide (FS@SiO₂-La₂O₃) (FSL) catalyst, according to certain embodiments;

FIG. 1C is a flowchart depicting a method for preparing a nickel-containing FSL catalyst (Ni@FS@SiO₂-La₂O₃) (Ni/FSL), according to certain embodiments;

FIG. 2A shows a transmission electron microscopic (TEM) image of the FSL support with 100 nm magnification, according to certain embodiments;

FIG. 2B shows a TEM image of the FSL support with 50 nm magnification, according to certain embodiments;

FIG. 2C shows a scanning electron microscopic (SEM) image of the FSL support, according to certain embodiments;

FIG. 3A shows an energy dispersive X-ray spectroscopy (EDS) spectrum obtained from Ni/FSL catalyst, illustrating a first elemental composition of the FSL support, according to certain embodiments;

FIG. 3B shows an EDS spectrum of the Ni/FSL obtained from the Ni/FSL catalyst, illustrating a second elemental composition of the FSL support, according to certain embodiments;

FIG. 4 depicts an X-ray diffraction (XRD) pattern of the FSL catalyst, according to certain embodiments;

FIG. 5A is a plotted graph depicting the effect of temperature on percentage conversion of carbon dioxide (CO₂) with the Ni/FSL catalyst, according to certain embodiments;

FIG. 5B is a plotted graph depicting the effect of temperature on percentage conversion of methane (CH₄) Ni/FSL catalyst, according to certain embodiments;

FIG. 5C is a plotted graph depicting the effect of temperature on the percentage yield of hydrogen gas (H₂) Ni/FSL catalyst, according to certain embodiments;

FIG. 5D is a plotted graph depicting the effect of temperature on the percentage yield of carbon monoxide (CO) Ni/FSL catalyst, according to certain embodiments; and

FIG. 5E is a plotted graph depicting the effect of temperature on syngas (H₂/CO) ratio with the Ni/FSL catalyst, according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise. As used herein, the term “room temperature” or “ambient temperature” generally refers to a temperature in a range of 25 degrees Celsius (° C.)+3° C. in the present disclosure.

As used herein, the term “porosity” refers to a measure of the void or vacant spaces within a material.

As used herein, the terms “particle size” and “pore size” may be thought of as the lengths or longest dimensions of a particle and of a pore opening, respectively.

As used herein, the term “sonication” generally refers to the process in which sound waves are used to agitate particles in a solution.

As used herein the term “de-ionized water” generally refers to the water that has (most of) the ions removed.

As used herein, the term “calcination” generally refers to heating a compound to a high temperature, under a restricted supply of ambient oxygen. This is performed to remove impurities or volatile substances and to incur thermal decomposition.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

As used herein, “compound” refers to a chemical entity, whether as a solid, liquid, or gas, and whether in a crude mixture or isolated and purified.

The present disclosure is intended to include all isotopes of a given compound or formula, unless otherwise noted. The present disclosure is intended to include all hydration states of a given compound or formula, unless otherwise noted or when heating a material.

Aspects of the present disclosure are directed toward a fibrous silica lanthanum oxide (FSL) catalyst and a nickel-containing FSL catalyst (Ni/FSL) with varied nickel content prepared by a microemulsion method a wet impregnation method. In some embodiments, the FSL catalyst and the Ni-FSL catalyst were tested respectively for their stability and catalytic activity in a fluidized-bed reactor under various reaction conditions, for dry reforming of methane (DRM). In some embodiments, the Ni/FSL catalyst is applicable for DRM, facilitating syngas production from greenhouse gases in an environmentally friendly manner.

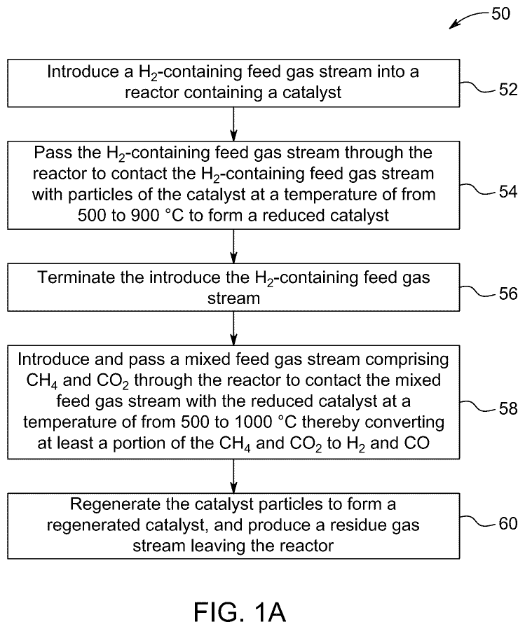

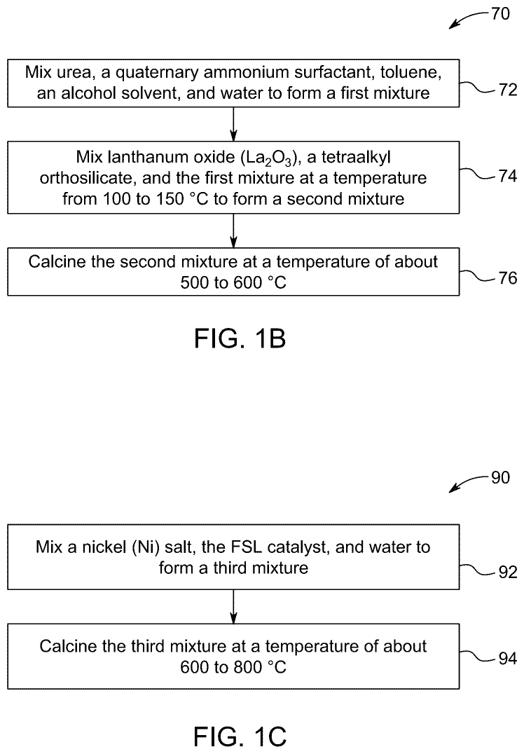

FIG. 1A illustrates a flow chart of a method 50 for dry reforming of methane (DRM). The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes introducing a H₂-containing feed gas stream into a reactor containing a catalyst. In some embodiments, the H₂-containing feed gas stream includes H₂ at a concentration of 1-20 volume percentage (vol. %), preferably 1-19 vol. %, preferably 2-18 vol. %, preferably 3-17 vol. %, preferably 4-16 vol. %, preferably 5-15 vol. %, preferably 6-14 vol. %, preferably 7-13 vol. %, preferably 8-12 vol. %, and preferably 9-11 vol. %, based on the total volume of the H₂-containing feed gas stream. Other ranges are also possible. In a specific embodiment, the H₂-containing feed gas stream includes H₂ at a concentration of 10 vol. %, based on the total volume of the H₂-containing feed gas stream. In some embodiments, the H₂-containing feed gas stream may further include an inert gas selected from the group consisting of nitrogen, argon, and helium. In some preferred embodiments, the inert gas is argon. The concentration of the inert gas, preferably argon, in the H₂-containing feed gas stream may be in the range of 80-99 vol. %, preferably 81-99 vol. %, preferably 82-98 vol. %, preferably 83-97 vol. %, preferably 84-96 vol. %, preferably 85-95 vol. %, preferably 86-94 vol. %, preferably 87-93 vol. %, preferably 88-92 vol. %, preferably 89-91 vol. %, preferably 90 vol. % based on the total volume of the H₂-containing feed gas stream. Other ranges are also possible. In some embodiments, a volume ratio of H₂ to the inert gas present in the H₂-containing feed gas stream is in a range of 1:1 to 1:20, preferably 1:2 to 1:18, preferably 1:3 to 1:15, preferably 1:4 to 1:10, preferably 1:5 to 1:9, preferably 1:9. Other ranges are also possible.

The reactor is at least one selected from the group consisting of a fixed-bed reactor, a trickle-bed reactor, a moving bed reactor, a rotating bed reactor, a fluidized-bed reactor, and a slurry reactor. In a specific embodiment, the reactor is a fluidized-bed reactor. In an embodiment, the reactor is the fluidized bed reactor in the form of a cylindrical reactor, including a top portion, a cylindrical body portion, a bottom portion, and a housing having an open top and open bottom supportably maintained with the cylindrical body portion. In some embodiments, the catalyst is supportably retained within the housing permitting fluid flow therethrough. In some embodiments, the bottom portion is cone-shaped or pyramidal. In some embodiments, at least one propeller agitator is disposed of in the bottom portion of the reactor. In some embodiments, a plurality of recirculation tubes fluidly connects the bottom portion of the cylindrical reactor with the cylindrical body portion of the cylindrical reactor. In some embodiments, at least one propeller agitator disposed in the bottom portion of the reactor.

The H₂ in the H₂-containing feed gas stream comes in contact with the catalyst in the reactor. In some embodiments, the catalyst is at least one of a FSL catalyst, and Ni/FSL catalyst. In an embodiment, the catalyst is the FSL catalyst. The FSL catalyst of the present disclosure includes about 10-40 wt. %, preferably 11-39 wt. %, preferably 12-38 wt. %, preferably 13-37 wt. %, preferably 14-36 wt. %, preferably 15-35 wt. %, preferably 16-34 wt. %, preferably 17-33 wt. %, preferably 18-32 wt. %, preferably 19-31 wt. %, preferably 20-30 wt. %, preferably 21-29 wt. %, preferably 22-28 wt. %, preferably 23-27 wt. %, and preferably 24-25 wt. % of lanthanum (La) as determined by energy-dispersive X-ray spectroscopy (EDS), and each wt. % based on the total weight of the FSL catalyst. Other ranges are also possible.

In some embodiments, the FSL catalyst has a porous structure including a plurality of spherical particles having an average particle size of less than 1 micrometers (μm), preferably less than 0.5 μm, preferably less than 100 nanometers (nm). Other ranges are also possible.

In an alternate embodiment, the FSL catalyst may exist in various morphological shapes, such as cones, cuboidal, pyramidical, cylindrical, wires, crystals, rectangles, triangles, prisms, disks, cubes, ribbons, blocks, beads, discs, barrels, granules, whiskers, flakes, foils, powders, boxes, stars, flowers, polygonal like trigonal, pentagonal, hexagonal, etc., and mixtures thereof. The porous structure includes pores that may be micropores, mesopores, macropores, and/or a combination thereof. In some embodiments, each of the plurality of spherical particles includes a fibrous network of interconnected nanoscale fibers having an average diameter of 0.5-25 nanometers (nm), preferably 1-24 nm, preferably 2-23 nm, preferably 3-22 nm, preferably 4-21 nm, preferably 5-20 nm, preferably 6-19 nm, preferably 7-18 nm, preferably 8-17 nm, preferably 9-16 nm, preferably 10-15 nm, preferably 11-14, and preferably 12-13 nm. Other ranges are also possible.

The crystalline structures of nickel-containing FSL (Ni/FSL) catalyst with various Ni content may be characterized by X-ray diffraction (XRD). In some embodiments, the XRD patterns are collected in a Powder X-ray diffraction (XRD, Bruker D8 Advance diffractometer) equipped with a Cu-Ka radiation source (2=0.15406 nm) for a 20 range extending between 2° and 80°, further preferably 30 and 60° at an angular rate of 0.005 to 0.04° s⁻¹, preferably 0.01 to 0.03° s⁻¹, or even preferably 0.02° s⁻¹.

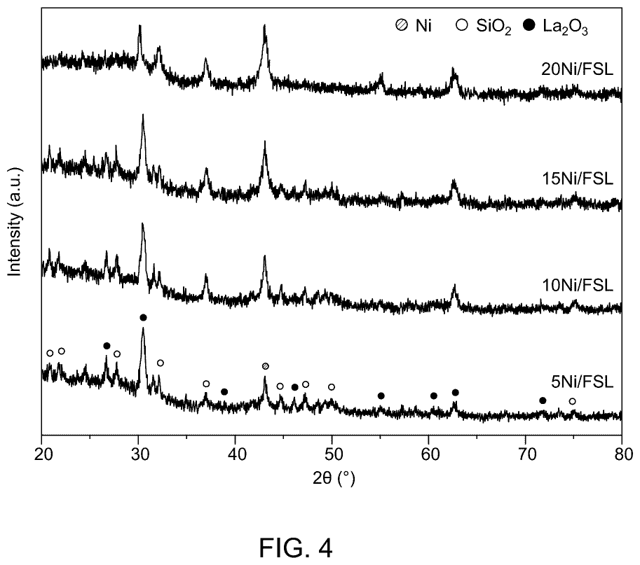

In some embodiments, the Ni/FSL catalyst has intense peaks with a 2 theta (0) value in a range of from 20 to 23°, preferably about 21.5°; from 23.8 to 24.8°, preferably about 24.3°; from 25.5 to 26.6°, preferably about 26.1°; from 26.6 to 27.5°, preferably about 26.8°; from 30.2 to 31.3°, preferably about 30.7°; from 31.5 to 32.6°, preferably about 32.1°; from 38.5 to 39.5°, preferably about 38.9°, from 42.8 to 43.8°, preferably about 43.3°; from 54.5 to 55.8°, preferably about 55.1°; from 58 to 59.5°, preferably about 58.7°; from 62.5 to 63.6°, preferably about 63.1°; and from 70 to 73°, preferably about 71.7° in an X-ray diffraction (XRD) spectrum, as depicted in FIG. 4. Other ranges are also possible.

In a preferred embodiment, the catalyst is the Ni/FSL. In some embodiments, the Ni/FSL catalyst includes about 15-35 wt. % of La, preferably 15-35 wt. %. preferably 16-34 wt. %. preferably 17-33 wt. %. preferably 18-32 wt. %. preferably 19-31 wt. % preferably 20-30 wt. % preferably 21-29 wt. % preferably 22-28 wt. % preferably 23-27 wt. % and preferably 24-26 wt. % of La; 5-20 wt. % of Ni, preferably 6-19 wt. %, preferably 7-18 wt. %, preferably 8-17 wt. %, preferably 9-16 wt. %, preferably 10-15 wt. %, preferably 11-14 wt. %, and preferably 12-13 wt. % of Ni; 25-50 wt. % of oxygen (O), preferably 26-54 wt. %, preferably 27-53 wt. %, preferably 28-52 wt. %, preferably 29-51 wt. %, preferably 30-50 wt. %, preferably 31-49 wt. %, preferably 32-48 wt. %, preferably 33-47 wt. %, preferably 34-46 wt. %, preferably 35-45 wt. %, preferably 36-44 wt. %, preferably 37-43 wt. %, preferably 38-42 wt. %, preferably 39-41 wt. % O; and 25 to 35 wt. % of silica (Si), preferably 26-34 wt. %, preferably 27-33 wt. %, preferably 28-32 wt. %, and preferably 29-31 wt. % of Si as determined by EDS, and each wt. % based on the total weight of the Ni/FSL catalyst. Other ranges are also possible.

At step 54, the method 50 includes passing the H₂-containing feed gas stream through the reactor to contact the H₂-containing feed gas stream with particles of the catalyst at a temperature of from 500-900 degrees Celsius (° C.), preferably 510-890° C., preferably 520-880° C., preferably 530-870° C., preferably 540-860° C., preferably 550-850° C., preferably 560-840° C., preferably 570-830° C., preferably 580-820° C., preferably 590-810° C., preferably 600-800° C., preferably 610-790° C., preferably 620-780° C., preferably 630-770° C., preferably 640-760° C., preferably 650-750° C., preferably 660-740° C., preferably 670-730° C., preferably 680-720° C., preferably 690-710° C., to form a reduced catalyst. Other ranges are also possible. In a specific embodiment, the H₂-containing feed gas stream is passed through the reactor to contact the H₂-containing feed gas stream with particles of the catalyst at a temperature of 700° C. to reduce the fresh catalyst. The process described thus far results in catalyst activation by reduction.

In some embodiments, the passing of the H₂-containing feed gas stream through the reactor is carried out at a flow rate of about 10-30 milliliters per minute (mL/min), preferably 11-29 mL/min, preferably 12-28 mL/min, preferably 13-27 mL/min, preferably 14-26 mL/min, preferably 15-25 mL/min, preferably 16-24 mL/min, preferably 17-23 mL/min, preferably 18-22 mL/min, and preferably 19-21 mL/min at a temperature of about 700° C. Other ranges are also possible. In a specific embodiment, the passing of the H₂-containing feed gas stream through the reactor is carried out at a flow rate of about 20 mL/min at a temperature of about 700° C. Other ranges are also possible.

At step 56, method 50 includes terminating the introduction of the H₂-containing feed gas stream. Once the catalyst is activated, the supply of H₂ to the reactor is stopped. The H₂ in the reactor is removed by purging the reactor under a continuous flow of an inert gas, preferably nitrogen, preferably argon, and more preferably helium. In a specific embodiment, the reactor temperature is purged under a continuous flow of argon.

At step 58, the method 50 includes introducing and passing a mixed feed gas stream, including methane (CH₄) and carbon dioxide (CO₂), through the reactor to contact the mixed feed gas stream with the reduced catalyst at a temperature of from 500-1000° C., preferably 525-975° C., preferably 550-950° C., preferably 575-925° C., preferably 600-900° C., preferably 625-875° C., preferably 650-850° C., preferably 675-825° C., preferably 700-800° C., and preferably 725-775° C. thereby converting at least a portion of the CH₄ and CO₂ to hydrogen (H₂) and carbon monoxide (CO). Other ranges are also possible. In some embodiments, the mixed feed gas stream further includes an inert gas selected from the group consisting of nitrogen, argon, and helium. In some embodiments, the passing the mixed feed gas stream through the reactor is carried out at a flow rate of about 10-30 mL/min, preferably 11-29 mL/min, preferably 12-28 mL/min, preferably 13-27 mL/min, preferably 14-26 mL/min, preferably 15-25 mL/min, preferably 16-24 mL/min, preferably 17-23 mL/min, preferably 18-22 mL/min, and preferably 19-21 mL/min. Other ranges are also possible. In a specific embodiment, the passing of the mixed feed gas stream through the reactor is carried out at a flow rate of about 20 ml/min. During this reaction, at least a portion of the catalyst particles from the reduced catalyst are spent to convert CH₄ and CO₂ to H₂ and CO. These catalyst particles may be regenerated for further re-use.

At step 60, the method 50 includes the catalyst particles to form a reduced catalyst and producing a residue gas stream leaving the reactor. In some embodiments, the catalyst particles may be regenerated by any method known to a person skilled in the art—for example, thermal treatment. In some embodiments, the residue gas stream leaving the reactor includes CH₄ CO₂, H₂, and CO. In some preferred embodiments, the residue gas stream leaving the reactor includes H₂ and CO. In some embodiments, a yield ratio of H₂ to CO present in the residue gas stream is in a range of 0.3-2.0, preferably 0.4-1.9, preferably 0.5-1.8, preferably 0.6-1.7, preferably 0.7-1.6, preferably 0.8-1.5, preferably 0.9-1.4, preferably 1.0-1.3, and preferably 1.1-1.3. In a preferred embodiment, the weight ratio of H₂ to CO present in the residue gas stream is 1.95 when the catalyst is the Ni/FSL catalyst containing about 5 wt. % of Ni based on the total weight of the Ni/FSL catalyst. Other ranges are also possible.

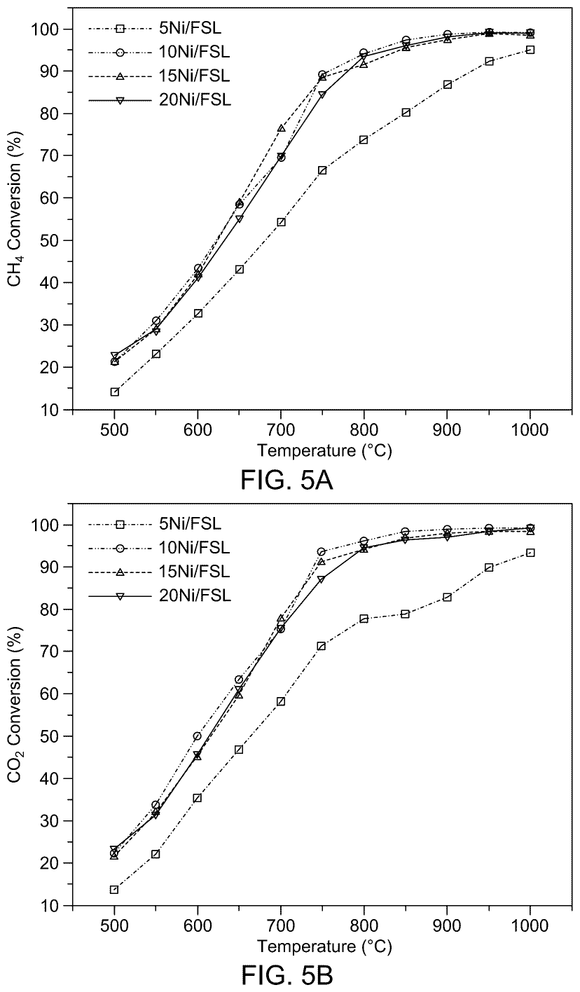

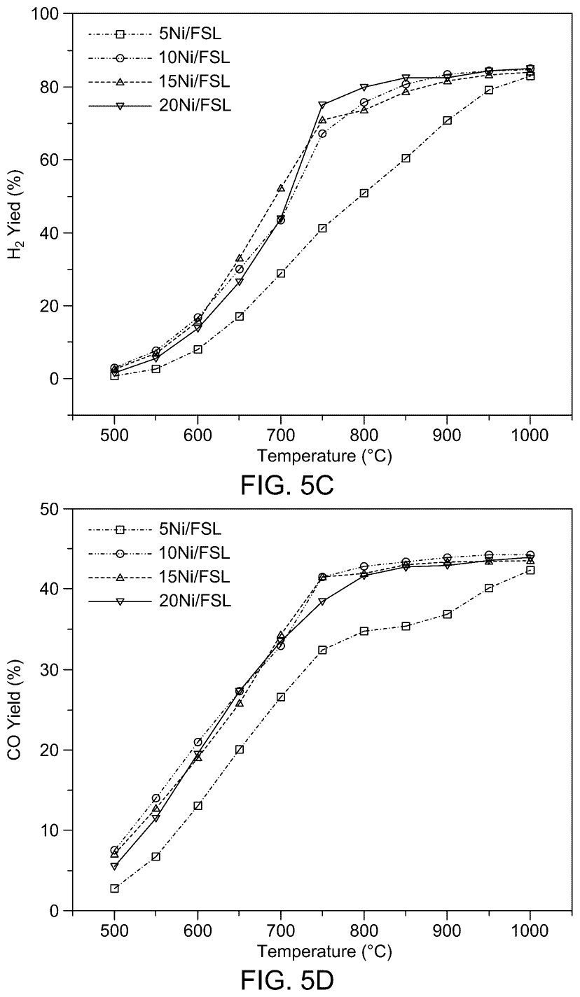

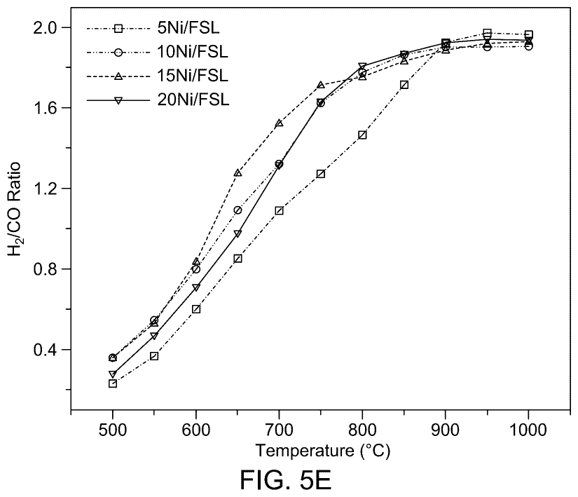

The method of the present disclosure has a H₂ yield of about 30-90%, preferably 35-85%, preferably 40-80%, preferably 45-75%, preferably 50-70%, and preferably 55-65% based on CH₄ conversion at a temperature from 700-1000° C., preferably 725-975° C., preferably 750-950° C., preferably 775-925° C., preferably 800-900° C., and preferably 825-875° C., as depicted in FIG. 5C. Other ranges are also possible. The CH₄ conversion is based on an initial concentration of the CH₄ in the mixed feed gas stream. In a preferred embodiment, the method results in about 88% yield of H₂ based on CH₄ conversion at a temperature of 900° C. Other ranges are also possible.

In some embodiments, the method has a CO yield of 25-48%, preferably 30-45%, and preferably 35-40%, based on a conversion of CH₄ and CO₂ at a temperature from 700-1000° C., preferably 725-975° C., preferably 750-950° C., preferably 775-925° C., preferably 800-900° C., and preferably 825-875° C., as depicted in FIG. 5D. Other ranges are also possible. The conversion of CH₄ and CO₂ is based on an initially combined concentration of the CH₄, and CO₂ present in the mixed feed gas stream. In a preferred embodiment, the method results in a CO yield of 45% based on a conversion of CH₄ and CO₂ at a temperature of 900° C. Other ranges are also possible.

In some embodiments, the Ni/FSL catalyst contains about 5 to 20 wt. % of Ni based on the total weight of the Ni/FSL catalyst. In one embodiment, the Ni/FSL catalyst with about 5 wt. % of Ni (5Ni/FSL) has a CO₂ conversion of about 15 to 25%, preferably about 20%, and a CH₄ conversion of about 15 to 25%, preferably about 20%, each based on an initial concentration of the CO₂ and CH₄ present in the mixed feed gas stream respectively at a temperature of about 550° C. In one embodiment, the Ni/FSL catalyst with about 10 wt. % of Ni (10Ni/FSL) has a CO₂ conversion of about 25 to 35%, preferably about 30%, and a CH₄ conversion of about 30 to 40%, preferably about 35%, each based on an initial concentration of the CO₂ and CH₄ present in the mixed feed gas stream respectively at a temperature of about 550° C. In one embodiment, the Ni/FSL catalyst with about 15 wt. % of Ni (15Ni/FSL) has a CO₂ conversion of about 15 to 25%, preferably about 20%, and a CH₄ conversion of about 15 to 25%, preferably about 20%, each based on an initial concentration of the CO₂ and CH₄ present in the mixed feed gas stream respectively at a temperature of about 550° C. In one embodiment, the Ni/FSL catalyst with about 20 wt. % of Ni (20Ni/FSL) has a CO₂ conversion of about 15 to 25%, preferably about 20%, and a CH₄ conversion of about 15 to 25%, preferably about 20%, each based on an initial concentration of the CO₂ and CH₄ present in the mixed feed gas stream respectively at a temperature of about 550° C. Other ranges are also possible.

In some preferred embodiments, the 10Ni/FSL catalyst may enhance the CO₂ conversion by at least 1 time, preferably at least 2 times, or even more preferably at least 4 times that that of a FSZ catalyst in the absence of Ni. In some further preferred embodiments, the 10Ni/FSL catalyst may enhance the CH₄ conversion by at least 1 time, preferably at least 2 times, or even more preferably at least 4 times than that of a FSZ catalyst in the absence of Ni. Other ranges are also possible.

In some preferred embodiments, the 10Ni/FSL catalyst may enhance the CO₂ conversion by at least 50%, preferably at least 80%, or even more preferably at least 100% than that of a catalyst selected from the group consisting of 5Ni/FSL catalyst, 15Ni/FSL catalyst, and 20Ni/FSL catalyst. In some further preferred embodiments, the 10Ni/FSL catalyst may enhance the CH₄ conversion by at least 50%, preferably at least 80%, or even more preferably at least 100% than that of a catalyst selected from the group consisting of 5Ni/FSL catalyst, 15Ni/FSL catalyst, and 20Ni/FSL catalyst. Other ranges are also possible.

FIG. 1B illustrates a flow chart of a method 70 for preparing the FSL catalyst. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 includes mixing urea, a quaternary ammonium surfactant, toluene, an alcohol solvent, and water to form a first mixture. In some embodiments, the quaternary ammonium surfactant is one or more selected from cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyldimethylammonium bromide (DEDTAB), decyltrimethylammonium bromide (D10TAB), and dodecyltriphenylphosphonium bromide (DTPB). In a preferred embodiment, the quaternary ammonium surfactant is CTAB.

Suitable examples of alcohol solvents include methanol, ethanol, propanol, isopropyl alcohol (IPA), butanol, pentanol, and mixtures thereof. In a preferred embodiment, the alcohol solvent is n-butanol (99%). The water may be tap water, distilled water, bi-distilled water, deionized water, deionized distilled water, reverse osmosis water, and/or some other water. In a preferred embodiment, the water is deionized water. The mixing may be carried out manually or with the help of a stirrer. In some embodiments, the urea is mixed with any quaternary ammonium surfactant, optionally in the presence of a co-surfactant, to form the first mixture.

At step 74, the method 70 includes mixing lanthanum oxide (La₂O₃), a tetraalkyl orthosilicate, and the first mixture at a temperature from 100-150° C., preferably 105-145° C., preferably 110-140° C., preferably 115-135° C., and preferably 120-130° C. to form a second mixture. In some embodiments, the tetraalkyl orthosilicate is at least one of tetraethyl orthosilicate (TEOS), tetramethyl orthosilicate, tetrapropyl orthosilicate, and tetrabutyl orthosilicate. In a preferred embodiment, the tetraalkyl orthosilicate is TEOS. The mixing may be carried out manually or with the help of a stirrer. In a preferred embodiment, the mixing is done at a temperature of 120° C. on a stirrer. Other ranges are also possible.

At step 76, the method 70 includes calcining the second mixture at a temperature of about 500-600° C., preferably 510-590° C., preferably 520-580° C., preferably 530-570° C., and preferably 540-560° C. Other ranges are also possible. The calcination is carried out by heating it to a high temperature, under a restricted supply of ambient oxygen. This is performed to remove impurities or volatile substances and to incur thermal decomposition. In a preferred embodiment, the calcining of the second mixture is done at a temperature of 550° C. Typically, the calcination is carried out in a furnace preferably equipped with a temperature control system, which may provide a heating rate of up to 50 degrees Celsius per minute (° C./min), preferably up to 40° C./min, preferably up to 30° C./min, preferably up to 20° C./min, preferably up to 10° C./min, preferably up to 5° C./min. Other ranges are also possible. In a preferred embodiment, the calcination is carried out in a furnace at a heating rate of 10° C./min. Other ranges are also possible.

FIG. 1C illustrates a flow chart of a method 90 for preparing the Ni/FSL catalyst. The order in which the method 90 is described is not intended to be construed as a limitation, and any number of the described method steps can be combined in any order to implement the method 90. Additionally, individual steps may be removed or skipped from the method 90 without departing from the spirit and scope of the present disclosure.

At step 92, the method 90 includes mixing a nickel (Ni) salt, the FSL catalyst, and water to form a third mixture. In some embodiments, the Ni salt includes nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate. In a preferred embodiment, the Ni salt is nickel (II) acetate tetrahydrate. The water may be tap water, distilled water, bidistilled water, deionized water, deionized distilled water, reverse osmosis water, and/or some other water. In a preferred embodiment, the water is deionized water. The mixing may be carried out manually or with the help of a stirrer.

At step 94, the method 90 includes calcining the third mixture at a temperature of about 600-800° C., preferably 620-780° C., preferably 640-760° C., preferably 660-740° C., and preferably 680-720° C. Other ranges are also possible. In a preferred embodiment, the calcination is done at a temperature of 700° C. in a furnace preferably equipped with a temperature control system, which may provide a heating rate of up to 50 degrees Celsius per minute (° C./min), preferably up to 40° C./min, preferably up to 30° C./min, preferably up to 20° C./min, preferably up to 10° C./min, preferably up to 5° C./min. Other ranges are also possible. In a preferred embodiment, the calcination is carried out in a furnace at a heating rate of 10° C./min. Other ranges are also possible.

### Examples

The following examples demonstrate a method for dry reforming of methane (DRM) using a fibrous silica lanthanum oxide (FSL) catalyst and a nickel-containing FSL catalyst (Ni/FSL). The examples are provided solely for illustration and are not to be construed as limitations of the present disclosure, as many variations thereof are possible without departing from the spirit and scope of the present disclosure.

### Example 1: Chemicals

All the chemicals were applied without any further modification and of analytical grade including lanthanum oxide, which is obtained from SPEX, urea from Hm-BG chemicals, toluene (99.9%) from BDH, n-butanol (99%) was obtained from Merck, tetraethyl orthosilicate (TEOS; 99%), and cetyltrimethylammonium bromide (CTAB) bought from Sigma Aldrich. All experiments and examples were conducted with deionized water (DI H₂O).

### Example 2: Synthesis of Catalyst

Lanthanum oxide was utilized as La₂O₃ seeds to produce fibrous silica lanthanum oxide (FS@SiO₂-La₂O₃), alternatively referred to as “FSL” hereinafter, without any limitations. The crystallization of the La₂O₃ seed was combined with the microemulsion technique to produce FSL. The synthesis process used the hydrolyzing agent urea, the surfactant CTAB, the oil phase toluene, and the co-surfactant n-butanol to aid in the development and stabilization of micelles. First, a solution was developed by dissolving about 3.48 grams (g) of about urea and about 5.82 g of CTAB in about 173 milliliters (mL) of distilled water. The mixture was then agitated for about 30 minutes at about 25° C. with about 173.9 mL of toluene and about 8.5 mL of n-butanol added. After adding about 1.6 g of La₂O₃ seeds, the solution combination was poured into a 500 ml bottle, followed by adding about 12.7 mL TEOS to the mixed solution while stirring for about 10 min. The mixed solution was stirred for 6 hours (h) and then held for about 8 h at about 120° C. After being rinsed with ethanol and centrifuged at 4000 rpm, the mixture was dried for about 12 h at about 120° C. The sample was then heated to about 550° C. for 6 h at a rate of about 10 degrees Celsius per minute (° C./min) in the atmosphere. For loading metal onto FSL, nickel (II) acetate tetrahydrate was impregnated using, e.g., about 5 wt. % Ni by impregnation method. This Ni precursor was soluble in DI H₂O. Before impregnation, the catalysts were dried by evaporating and then calcined for about 150 minutes at about 700° C. This process produced powder, which was tagged with Ni/FSL.

### Example 3: Catalytic Reaction

A DRM reaction was carried out in a fluidized-bed reactor that was heated by a furnace equipped with a programmable temperature controller at atmospheric pressure to examine the impact of surface morphology, stability, and catalyst activity. In one embodiment, about 0.2 g of the prepared catalysts, with a particle size, e.g., preferably between 300 micrometers (μm) to 500 μm, was loaded over quartz wool after being placed in the middle of the reactor. The catalyst was reduced at about 700° C. for two hours before the reaction under a mixture of about 10 volume percentage (vol. %) H₂ balance with argon while flowing at a rate of about 20 milliliters per minute (ml/min). After the reduction, the reactor was chilled to the reaction temperature. The mixture of CH₄: CO₂ was introduced into the reactor, e.g., preferably in a 1:1 ratio at a flow rate of about 20 mL/min. The reactor was programmed to increase from 500° C. to 1000° C. with an interval of 50° C. to study the catalytic activity. The gas of both the reactants was examined, and the products were carried out by online gas chromatography (6890 N Agilent GC) equipped with the thermal conductivity detector (TCD). The following equations were applied to determine the conversion of the reactants, produced products, and the H₂/CO ratio,

$${CH}_{4} Conversion = \frac{{F}_{( C {H}_{4} ) in} - {F}_{( C {H}_{4} ) out}}{{F}_{( C {H}_{4} ) in}} \times 100 \qquad Eq . 1$$

$${CO}_{2} Conversion = \frac{{F}_{( {CO}_{2} ) in} - {F}_{( {CO}_{2} ) o u t}}{{F}_{( {CO}_{2} ) in}} \times 100 \qquad Eq . 2$$

$${H}_{2} Selectivity = \frac{{F}_{( {H}_{2} ) o u t}}{2 [ {F}_{( {CH}_{4} ) in} - {F}_{( {CH}_{4} ) out} ]} \times 100 \qquad Eq . 3$$

$$CO Selectivity = \frac{{F}_{( CO ) out}}{[ {F}_{( {CH}_{4} ) in} - {F}_{( {CH}_{4} ) out} ] + [ {F}_{( {CO}_{2} ) in} - {F}_{( {CO}_{2} ) out} ]} \times 100 \qquad Eq . 4$$

$${H}_{2} / CO = \frac{{F}_{( {H}_{2} ) out}}{{F}_{( CO ) out}} \qquad Eq . 5$$

where F (in) is the inlet flow rate and F (out) is the outflow rate.

### Example 4: Morphological Properties

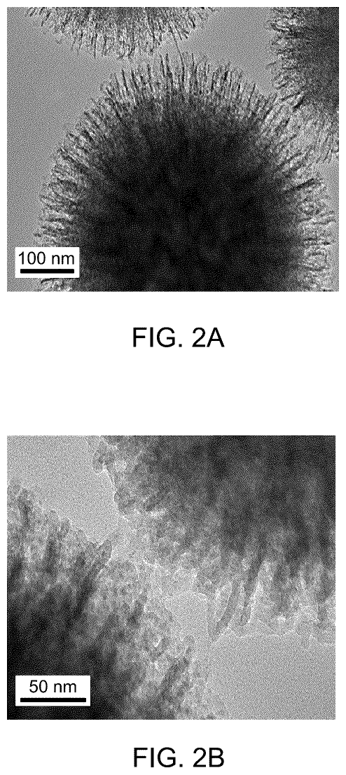

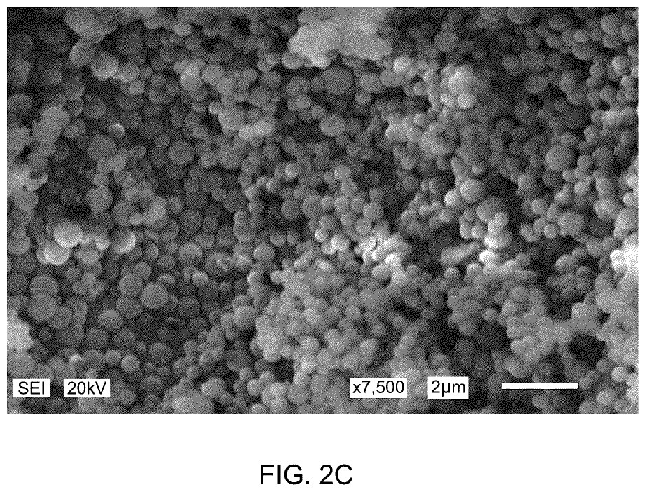

Scanning electron microscopy (SEM) and transmission electron microscopy (TEM) were used to examine the morphology and structures of the generated material as shown in FIGS. 2A-2C. TEM was utilized to examine the microstructure of the FSL support with dimensions of 100 nanometers (nm) and 50 nm. The TEM images of the 100 nm FSL support contains interconnected nanofibers forming a porous and three-dimensional network as shown in FIG. 2A. The fibers exhibited variations in diameter and length, contributing to the high surface area and potential porosity of the material. A similar fibrous structure was observed in the TEM image of the 50 nm FSL support, but with smaller dimensions as shown in FIG. 2B. The nanofibers appeared finer and more closely packed, resulting in an even higher surface area and increased porosity than the 100 nm counterpart. The TEM images also indicated the presence of lanthanum and silicon within the fibrous silica matrix. The structural details observed in these TEM images may impact the nanoscale features of the FSL support, which may also have affected its applications as a catalyst support or in other nanotechnology-related fields. The SEM images provided a detailed view of the surface characteristics of the FSL support. The SEM micrographs showed interconnected nanoscale fibers, forming a fibrous network with a porous structure. The fibers exhibited variations in diameter and length, contributing to the material's high surface area and potential porosity. The surface of the FSL support appeared to be relatively smooth, with occasional rough regions. The SEM analysis also showed the presence of lanthanum, depicted by the elemental mapping of the material. The distribution of lanthanum on the surface of the fibrous silica was observed, demonstrating its spatial arrangement within the support. The SEM examination shows the surface morphology and elemental composition of the FSL support, which finds applications in domains like catalyst support or others based on nanotechnology A force among the surfactant (CTAB), co-surfactant (1-butanol), oil phase (toluene), and aqueous phase (water) led to the production of cockscomb-shaped morphology during the microemulsion process, which aided in the development of FSL composite. The SEM test was performed to show the microstructure of these produced nanospheres, as depicted in FIG. 2C. These fibers are formed from silica species. A large, uneven inter-fiber distance was observed to show the prepared catalyst's textural characteristics. This developed catalyst may be advantageous, increasing the surface area and meso-porosity of the produced FSL.

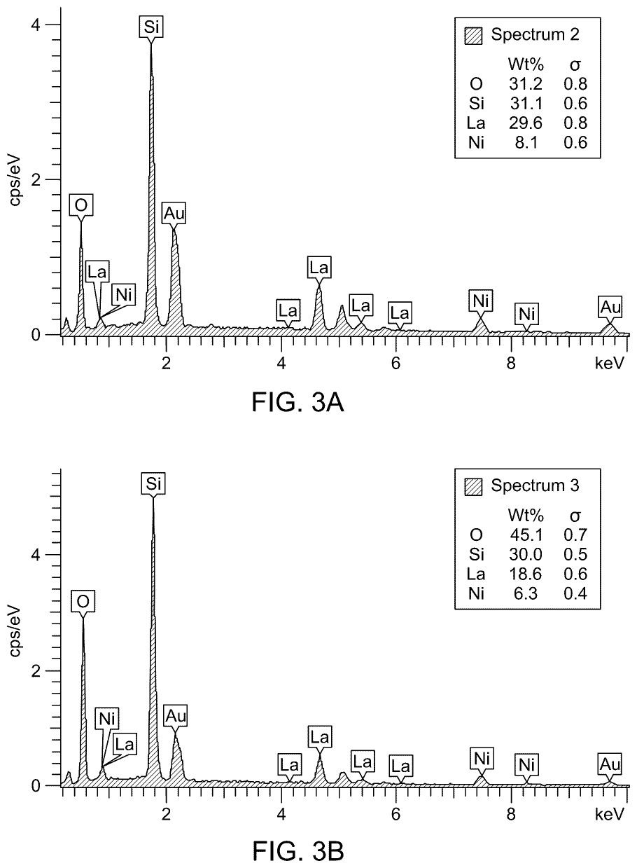

Energy-dispersive X-ray Spectroscopy (EDS) was utilized in conjunction with SEM to analyze the elemental composition of the FSL support shown in FIGS. 3A-3B. The EDS spectrum of FSL revealed characteristic peaks corresponding to the elements present in the material. Major peaks were observed for silicon (Si) and lanthanum (La), confirming the presence of both constituents in the fibrous structure. The intensity and position of these peaks provided quantitative information about their relative abundance in the sample. Moreover, the EDS map of FSL displayed the spatial distribution of these elements, showing their arrangement within the fibrous silica network. It allowed for the visualization of areas with higher concentrations of silicon and lanthanum, enabling the identification of potential elemental gradients or non-uniformities in the support material. The chemical composition and homogeneity of FSL were determined by a combined EDS-SEM analysis, thereby examining its performance for specific applications in various industries, such as catalysis, nanotechnology, or advanced materials.

### Example 5: Structural Properties

X-ray diffraction (XRD) examination was performed to determine the crystallinity and structure of the produced catalyst. The XRD patterns of the FSL catalyst, as depicted in FIG. 4, showed various diffraction peaks at 21.5°, 24.3°, 26.1°, 26.8°, 30.7°, 32.1°, 38.9°, 43.3°, 55.1°, 58.7°, 63.1° and 71.7° at 20=20°-80°. The FSL catalyst synthesized was in the uncontaminated shape of the orthorhombic phase of the structure. The FSL exhibited reduced diffraction peak intensity, indicating that the produced catalyst loses organizational integrity throughout the fabrication procedure. The result shows that the crystallinity of the FSL is reduced due to the growth of silica fibers on La₂O₃ (See: M. L. Firmansyah and researchers, “Synthesis and characterization of fibrous silica ZSM-5 for cumene hydrocracking,” Catal Sci Technol, vol. 6, no. 13 and S. M. Izan and researchers, “Additional Lewis acid sites of protonated fibrous silica@BEA zeolite (HSi@BEA) improving the generation of protonic acid sites in the isomerization of C6 alkane and cycloalkanes,” Appl Catal A Gen, vol. 570, which is incorporated herein by reference in its entirety).

### Example 6: Catalytic Activity

The DRM activity of the nickel-fibrous silica lanthanum oxide (Ni/FSL) exhibited a dependence on the nickel content. In some embodiments, the 5% Ni/FSL catalyst demonstrated a CO₂ conversion of 20% at a temperature of 550° C. As the nickel content was enhanced to 10%, the CO₂ conversion improved, reaching a value of about 30% under the same reaction conditions. Further increase of the nickel content to 15% may lead to a slight reduction in CO₂ conversion at the same temperature shown in FIG. 5A. Similarly, regarding CH₄ conversion, the 5% Ni/FSL catalyst showed a CH₄ conversion of 20% at 550° C., while the 10% Ni/FSL catalyst exhibited a CH₄ conversion of 35% under similar conditions. The 15% and 20% Ni/FSL catalyst slightly reduced CH₄ conversion at the same temperature shown in FIG. 5B. For all specimens, the CO₂ and CH₄ conversions increased by 650° C. to 900° C. as shown in FIG. 5A and FIG. 5B. The percentage yield of H₂ and CO was also investigated for each catalyst. FIG. 5C shows the 10% Ni/FSL exhibited high % yield of H₂, reaching about 88%, while the 5% Ni/FSL, 15% Ni/FSL, and 20% Ni/FSL showed lower percentage yields of H₂ at 70% 82% and 84%, respectively. As can be seen from FIG. 5D, for CO production, the 10% Ni/FSL catalyst demonstrated the high percentage yield of CO at 45%, outperforming the 5% Ni/FSL, 15% Ni/FSL, and 20% Ni/FSL, which achieved percentage yields of CO at 35%, 42%, and 40%, respectively. Another factor in DRM is the H₂/CO ratio, which shows reliant on nickel content. The 10% Ni/FSL had the best H₂/CO ratio, with a value of 1.95, indicating hydrogen-rich syngas production. In contrast, the 5% Ni/FSL, 15% Ni/FSL, and 20% Ni/FSL displayed lower H₂/CO ratios, as shown in FIG. 5E.

A method of synthesis of catalysts for DRM reactions. In particular, the performance of the Ni/FSL catalyst for the DRM reaction was assessed, a method for converting CO₂ and methane into syngas, with a plurality of Ni contents such as, but not limited to, 5%, 10%, and 15%. The present disclosure describes the effect of nickel on the catalytic efficiency of the DRM reaction. The catalysts were prepared using a microemulsion process, and their microstructure and elemental makeup were examined using SEM, TEM, EDS, and XRD. The generation of syngas from two plentiful resources, CO₂ and CH₄, is made possible by DRM, providing a procedure for converting sustainable energy. The presence of nickel in the catalysts facilitates the activation of CH₄ and CO₂, promoting their transformation into syngas, consisting of CO and H₂. The present disclosure revealed that the catalytic activity of the Ni/FSL nanocomposites may be affected by the nickel content. The 10% Ni/FSL catalyst demonstrated improved performance in DRM, displaying higher CH₄ conversion and CO₂ conversion than the 5%, 15%, and 20% Ni/FSL counterparts. Further, the selectivity towards syngas components (H₂ and CO) also exhibited dependence on the nickel content. The 10% Ni/FSL catalyst yielded high percentages of H₂ and CO, indicating enhanced production of valuable syngas, unlike the 5%, 15%, and 20% Ni/FSL catalysts exhibited lower selectivity towards syngas components. Furthermore, the present disclosure that the 10% Ni/FSL nanocomposite holds the most promising catalytic activity for DRM, delivering improved CH₄ conversion, CO₂ conversion, and selectivity towards H₂ and CO. These results show that Ni/FSL catalysts were suitable for sustainable DRM process to generate syngas. The utilization of such catalysts may contribute significantly to advancing clean energy technologies and mitigating greenhouse gas emissions.

Numerous modifications and variations of the present disclosure are possible in light of the above teachings. It is therefore to be understood that within the scope of the appended claims, the invention may be practiced otherwise than as specifically described herein.

1: A method for dry reforming of methane (DRM), comprising:
introducing a hydrogen (H₂)-containing feed gas stream into a reactor containing a catalyst;
wherein the catalyst is at least one selected from the group consisting of a fibrous silica lanthanum oxide (FSL) catalyst, and a nickel-containing FSL (Ni/FSL) catalyst;
passing the H₂-containing feed gas stream through the reactor to contact the H₂-containing feed gas stream with particles of the catalyst at a temperature of from 500° C. to 900° C. to form a reduced catalyst;
terminating the introducing the H₂-containing feed gas stream; and
introducing and passing a mixed feed gas stream comprising methane (CH₄) and carbon dioxide (CO₂) through the reactor to contact the mixed feed gas stream with the reduced catalyst at a temperature of from 500° C. to 1000° C. thereby converting at least a portion of the CH₄ and CO₂ to H₂ and CO and regenerating the catalyst particles to form a regenerated catalyst and producing a residue gas stream leaving the reactor.

2: The method of claim 1, wherein H₂ is present in the H₂-containing feed gas stream at a concentration of 1 volume percentage (vol. %) to 20 vol. % based on a total volume of the H₂-containing feed gas stream.

3: The method of claim 1, wherein the H₂-containing feed gas stream further comprises an inert gas selected from the group consisting of nitrogen, argon, and helium.

4: The method of claim 1, wherein the mixed feed gas stream further comprises an inert gas selected from the group consisting of nitrogen, argon, and helium.

5: The method of claim 1, wherein the reactor is at least one selected from the group consisting of a fixed-bed reactor, a trickle-bed reactor, a moving bed reactor, a rotating bed reactor, a fluidized bed reactor, and a slurry reactor.

6: The method of claim 1, wherein the reactor is a fluidized bed reactor in the form of a cylindrical reactor comprising:
a top portion;
a cylindrical body portion;
a bottom portion;
a housing having an open top and open bottom supportably maintained with the cylindrical body portion;
wherein the catalyst is supportably retained within the housing permitting fluid flow therethrough;
at least one propeller agitator disposed in the bottom portion of the reactor;
wherein the bottom portion is cone shaped or pyramidal; and
wherein a plurality of recirculation tubes fluidly connects the bottom portion of the cylindrical reactor with the cylindrical body portion of the cylindrical reactor.

7: The method of claim 1, wherein the passing the H₂-containing feed gas stream through the reactor is carried out at a flow rate of about 10 milliliters per minute (mL/min) to 30 mL/min at a temperature of about 700° C.

8: The method of claim 1, wherein the passing the mixed feed gas stream through the reactor is carried out at a flow rate of about 10 mL/min to 30 mL/min.

9: The method of claim 1, wherein a weight ratio of H₂ to CO present in the residue gas stream is in a range of 0.3 to 2.0.

10: The method of claim 1, having a H₂ yield of 30% to 90% based on CH₄ conversion at a temperature of from 700° C. to 1000° C., and wherein the CH₄ conversion is based on an initial concentration of the CH₄ in the mixed feed gas stream.

11: The method of claim 1, having a CO yield of 25% to 48% based on a conversion of CH₄ and CO₂ at a temperature of from 700° C. to 1000° C., and wherein the conversion of CH₄ and CO₂ is based on an initially combined concentration of the CH₄, and CO₂ present in the mixed feed gas stream.

12: The method of claim 1, wherein the catalyst is the FSL catalyst, and wherein the method further comprises preparing the FSL catalyst by:
mixing urea, a quaternary ammonium surfactant, toluene, an alcohol solvent, and water to form a first mixture;
mixing lanthanum oxide (La₂O₃), a tetra alkyl orthosilicate, and the first mixture at a temperature of from 100° C. to 150° C. to form a second mixture; and
calcining the second mixture at a temperature of about 500° C. to 600° C.

13: The method of claim 12, wherein the quaternary ammonium surfactant is at least one selected from the group consisting of cetyltrimethylammonium bromide (CTAB), cetyltrimethylammonium chloride (CTACl), tetradecyltrimethylammonium bromide (TTAB), tetradecyltrimethylammonium chloride (TTACl), dodecyltrimethylammonium bromide (DTAB), dodecyltrimethylammonium chloride (DTACl), dodecylethyldimethylammonium bromide (DEDTAB), decyltrimethylammonium bromide (D10TAB), and dodecyltriphenylphosphonium bromide (DTPB).

14: The method of claim 12, wherein the tetra alkyl orthosilicate is at least one selected from the group consisting of tetraethyl orthosilicate (TEOS), tetramethyl orthosilicate, tetrapropyl orthosilicate and tetrabutyl orthosilicate.

15: The method of claim 12, wherein the FSL catalyst comprises about 10 weight percentage (wt. %) to 40 wt. % of lanthanum (La) as determined by energy-dispersive X-ray spectroscopy (EDS), and each wt. % based on a total weight of the FSL catalyst.

16: The method of claim 12, wherein the FSL catalyst has a porous structure comprising a plurality of spherical particles having an average particle size of 100 nanometers (nm) to 0.5 micrometer (μm).

17: The method of claim 16, wherein each of the plurality of spherical particles comprises a fibrous network of interconnected nanoscale fibers having an average diameter of 0.5 nanometers (nm) to 25 nm.

18: The method of claim 1, wherein the catalyst is the Ni/FSL catalyst, and wherein the method further comprises preparing the Ni/FSL catalyst by:
mixing a nickel (Ni) salt, the FSL catalyst, and water to form a third mixture; and
calcining the third mixture at a temperature of about 600° C. to 800° C.

19: The method of claim 18, wherein the Ni salt comprises nickel sulfate, nickel acetate, nickel citrate, nickel iodide, nickel chloride, nickel perchlorate, nickel nitrate, nickel phosphate, nickel triflate, nickel bis(trifluoromethanesulfonyl)imide, nickel tetrafluoroborate, nickel bromide, and/or its hydrate.

20: The method of claim 18, wherein the Ni/FSL catalyst comprises about 15 wt. % to 35 wt. % of La, 5 wt. % to 20 wt. % of Ni, 25 wt. % to 50 wt. % of oxygen (O), and 25 wt. % to 35 wt. % of silica (Si) as determined by EDS, and each wt. % based on a total weight of the Ni/FSL catalyst.
